(19) United States
(12) Patent Application Publication
(10) Pub. No.: US 2026/0052588 A1
(43) Pub. Date: Feb. 19, 2026

(54) PURPOSE DRIVEN SECURE COMMUNICATIONS PLATFORM

(71) Applicant: MOVIUS INTERACTIVE CORPORATION,, Alpharetta, GA (US)

(72) Inventors: Amit Modi, Fremont, CA (US); Paul Rubenstein, Roswell, GA (US)

(73) Assignee: MOVIUS INTERACTIVE CORPORATION, Alpharetta, GA (US)

(21) Appl. No.: 18/809,032

(22) Filed: Aug. 19, 2024

(51) Int. Cl. H04W 76/11; H04W 40/02

(52) U.S. Cl. CPC H04W 76/11; H04W 40/02

(57) ABSTRACT

Servicing a communication from an originating station directed to one or more destination stations. A communication is received from an originating station and includes a unique identifier that is associated with the originating station and a destination identifier. A communication platform receives the communication either directly or from a telecommunications system component that recognizes the communication as being processed by the communications platform. The communication platform identifies the source of the communication and the destination of the communication. The communication platform sets up a communications channel/session between the stations and performs any conversion necessary for the destination to understand the originating station and vice versa. The communication platform routes the communication between the originating and destination stations and may enter the communication into an archive for a user associated with the originating station and/or destination session.

### CROSS-SECTION TO RELATED APPLICATIONS

This application incorporates and implements certain technology found in U.S. Pat. No. 9,332,128 issued on May 3, 2016, and U.S. Pat. No. 11,563,711 issued on Jan. 24, 2023, both of which are hereby incorporated by reference in their entirety.

### BACKGROUND

I am sure you have heard the old proverb “necessity is the mother of invention”. This proverb has been applied to Aesop's famous fable “The Crow and the Pitcher” where a thirsty crow happens up a pitcher that is partially filled with water. But the crow cannot reach down into the pitcher to get a drink. The crow then begins collecting pebbles to drop into the pitcher, thereby causing the water to rise to a level where the thirsty crow can have a drink. But is this proverb always true?

In many instances throughout life, inventions have been made well before their time of usefulness or feasibility. The one I think we are all waiting on is the STAR TREK teleporting system. Other inventions that were given birth to decades before they found practical applications and implementations include the jet pack, contact lenses, solar cells and vending machines. In addition, there are also many examples in which invention became the mother for necessity rather than necessity being the mother of invention. This occurs when a technology emerges to solve one problem, but then creates, one or more, or even a myriad of other problems. The present state of the telecommunications industry is a perfect example of invention being the mother of necessity. In today's world we have so many differing technologies that keep us all “connected” that we tend to be “disconnected” trying to organize and operate our “connectedness”.

For instance, within the workplace, the use of telecommunications technology can make a business vulnerable to corporate espionage or simply losing critical business information, can make engagement with customers complicated and can distract employees and reduce their productivity. Thus, there is a need in the art for a telecommunications solution that provides security and trust to a business, enables employees to engage with customers over various channels and in various fashions all while providing cost and time savings to the company and not cramping the workstyle preferences of the employees.

A problem that is ever present in the telecommunications industry is that the plethora of messaging, engaging or calling technologies on various communication platforms all operate independently. As such, User A utilizing a messaging application to communicate with User B has no view into communications with User B when User A utilizes other communication means, such as a video conferencing application, a mobile telephone, a funds transfer, etc. This problem is further exacerbated by the identifiers associated with each one of these messaging or calling communication technologies being unique in their own siloed and closed ecosystem. For instance, the identifiers used to recognize a user or device engaging in a video conference are unknown and unrecognized by a voice call system, messaging system, etc. Further, the different communication means also speak different languages (i.e. use different information transfer protocols). As such, the various communication platforms may not recognize a party or device that operates with another communication platform nor speak the language.

### SUMMARY OF THE DISCLOSURE

While the U.S. Pat. No. 9,332,128 (incorporated herein above) brought the notion of a Second Telephone number creating an identity for communications, this new invention now creates and includes a breakthrough where all channels of communications are tied to a Single Number (a single unique identity) that is relatable, can tie disparate fragmented communication ecosystems together, and is relevant well beyond its' closed isolated ecosystem only. This is a disruptive technological development because with one identifier, which could very well be/but is not limited to a mobile device's SIM or ESIM number, multiple channels of communication and multiple endpoints of communication can all be tied together in one simple cohesive manner. Advantageously, this results in rendering peace of mind for the businesses and peace of mind to the end users of the services that can now engage in communication across all silo boundaries with other entities regardless of the device, technology, communication application or technique they are using. Users can utilize a communications technology that they are familiar with or comfortable with regardless of the communications technology being utilized by the party (ies) with which they are communicating.

An embodiment of the present invention includes a method or process for servicing a communication from an originating entity. Initially a communication initiation is received from an originating entity or originating EUD at a telecommunications network component. The communication initiation includes among other information, a unique identifier, which is associated with the originating entity, and a destination entity identifier. The originating entity and the destination entity can be any of a variety of end user devices (EUDs).

The communication initiation is either received by a component operating on a telecommunications network and then forwarded to a communications platform or, is directly received by the communications platform. In either case, the communication initiation is parsed to detect the unique identifier within the communication initiation.

If a network component receives the communications initiation, it forwards it to the communications platform upon discovering the unique identification and recognizing that the unique identifier is one that is serviced by the communications platform and is supposed to process this communications initiation. Thus, the telecommunications network component provides the communication initiation, based at least in part on the unique identifier, to a communications platform. It should be appreciated that in some embodiments, the telecommunications network component is integrated with or one and the same as the communication platform, in which case the communication initiation is received and processed by the same entity or modules within the same entity, or tandem systems.

The communication platform identifies the source of the communication initiation and the destination entity of the communication and then establishes a communication channel between the originating entity and the destination entity. The channel establishment includes stablishing a first leg of the communication channel between the communication platform and the destination entity and establishing a second leg of the communication channel between the communication platform and the originating entity.

The first leg of the communication channel utilizes a telecommunications technology compatible with the destination entity. The second leg of the communication channel utilizes a telecommunications technology compatible with the originating entity. Thus, the communications platform establishes a communication path to the destination entity EUD that is technically compatible with the destination entity EUD and a communication path to the originating entity EUD that is technically compatible with the originating entity EUD. Thus, in one example, at least one of the destination entity EUD and the originating entity EUD is a video conferencing application and the action of establishing the communication path includes establishing a communication path that can carry video and audio to/from the destination entity EUD and/or the originating entity EUD. As another example, at least one of the destination entity EUD and the originating entity EUD is a messaging application and the action of establishing the communication path includes establishing a communication path that can carry text messages to/from the destination entity EUD and/or the originating entity EUD.

Once the communication channel is established, communications then flow between the originating entity and the destination entity (or multiple entities if it is a group communication). The subsequent communications may include the unique identifier for directing the traffic or simply identify the channel.

Thus, in response to receiving a communication transmission from the originating entity for the destination entity, the communication platform performs any conversion necessary for the destination entity to understand the communication transmission from the originating entity. Likewise, in response to receiving a communication transmission from the destination entity to the originating entity, the communication platform performs any conversion necessary for the originating entity to understand the communication transmission from the destination entity. The communication platform then routes the translated communication transmissions between the originating entity and the destination entity.

Another embodiment of the present invention includes a system for servicing a communication from an originating entity. The system comprises a communications platform that is communicatively coupled to a telecommunications network through a plurality of interfaces. The communications platform is configured to receive a communication initiation through a telecommunications network component, wherein the communication initiation is sent from an originating entity and includes a unique identifier, which is associated with the originating entity, and a destination entity identifier. The communication initiation is parsed and if the unique identifier is detected, the source of the communication initiation and the destination entity of the communication initiation are known. In response, a communication channel between the originating entity and the destination entity is established.

Subsequent to establishing the communication channel, the communications platform is configured to receive a communication transmission from the originating entity for the destination entity. In response, the communications platform performs any conversion necessary for the destination entity to understand the communication transmission from the originating entity and routes the translated communication transmission form the originating entity to the destination entity using an interface of the plurality of interfaces that is compatible with the destination entity.

The communications platform is also configured to receive a communication transmission from the destination entity to the originating entity. Ion response, the communications platform performs any conversion necessary for the originating entity to understand the communication transmission from the destination entity and routes the translated communication transmission to the originating entity using an interface of the plurality of interfaces that is compatible with the originating entity.

The plurality of interfaces of the communications platform may include two or more interfaces selected from a group of interfaces comprising:
an application program interface to a messaging service;
an interface to a social messaging platform;
an interface to a Customer Relationship Management (CRM) system;
an interface to an enterprise collaboration system; and
an interface to a private branch exchange system.

Further, in some embodiments the group of interfaces includes an interface to an archival system and the communications platform is configured to store a history of the translated communication transmissions from and to the originating entity.

These and other embodiments, features, aspects, advantages, etc. of the present invention are further described in connection with the following drawings and the detailed description.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral encompass all parts having the same reference numeral in all figures.

FIG. 1 is a functional diagram illustrating the telecommunications integration goal of various embodiments of the present invention.

FIG. 2 is a functional block diagram illustrating the operation of an exemplary communications platform interacting with a carrier partner providing certain integrated communication services.

FIG. 3 is a flow diagram illustrating a first communication exchange example based on an exemplary architecture such as that illustrated in FIG. 2 as a non-limiting example.

FIG. 4 is a flow diagram illustrating a communication exchange example based on an exemplary architecture such as that illustrated in FIG. 2.

FIG. 5 is a flow diagram illustrating another communication exchange example based on an exemplary architecture such as that illustrated in FIG. 2.

FIG. 6 is a sky of clouds illustrating the overall operation of an embodiment of an exemplary communications platform 602.

FIG. 7 is a functional block diagram of the components of an exemplary embodiment of system or sub-system operating as a controller or processor 700 that could be used in various embodiments of the disclosure for controlling aspects of the various embodiments.

### DETAILED DESCRIPTION

The word “exemplary” is used herein to mean “serving as an example, instance, or illustration.” Any aspect described herein as “exemplary” is not necessarily to be construed as preferred or advantageous over other aspects.

One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “telecommunications device,” “communication device,” “wireless device,” “wireless telephone,” “wireless communication device” and “wireless handset” are used interchangeably. With the advent of third generation (“3G”), fourth generation (“4G”), fifth generation (“5G”), and beyond wireless technology, greater bandwidth availability has enabled more portable computing devices with a greater variety of wireless capabilities. Therefore, a telecommunications device (“TD”) may include a cellular telephone, a pager, a PDA, a smartphone, a navigation device, a tablet personal computer (“PC”), a hand-held computer with a wireless connection or link, a watch, a chip embedded within an individual and integrated within the brain, nervous system and muscular system, etc.

In this description, the terms “call” and “communication,” in their noun forms, envision any data transmission routed across a network from one device to another including, but not limited to, a voice transmission, a text message, a video message, a page, a data transmission, etc.

Turning now to the figures in which like elements are represented by similar labels, various embodiments, as well as aspects, features and characteristics of the embodiments are presented in more detail.

The heart of today's telecommunication industry is found in wireless based networks serving as the integration of mobile and wireless devices into the historical public switched network technology (“PSTN”). However, the use of the PSTN to reach into homes and businesses has been greatly replaced using wireless technology, while the backbone of the PSTN is still in use. But wireless and mobile networks are quite varied and exist in a variety of telecommunications technologies, such as 3G, 4G, 5G, LTE, GSM, etc., as well as other wireless technology including WIFI, BLUETOOTH, INFRARED, BROADCAST RADIO, MICROWAVE, and even satellite technologies. Each of these technologies have similarities and differences.

A goal or object of the various embodiments of the present invention is to provide a technique, technology, solution, methodology, etc. that enables the widest array of end user devices to communicate with other end user devices and provide compatibility no matter what protocol or technology being utilized. Throughout this description, the term end user device is used to refer to any element that can originate and/or receive a communication. Thus, as non-limiting examples, end user devices (sometimes referred to herein as EUDs) may be mobile telephones, smart phones, tablets, note pads, IPADS, notebook computers, desktop computers, personal data assistants, POTS devices, applications running on any of the afore mentioned devices such as messaging applications, video conference applications, voice messaging applications, financial transaction devices, point of sale terminals, CRM applications, social media applications, PBXs, archival applications, enterprise collaboration applications, healthcare integrations, etc. As such, a EUD may be an application running on a mobile telephone, or it may be a hardware enablement of a mobile telephone, etc.

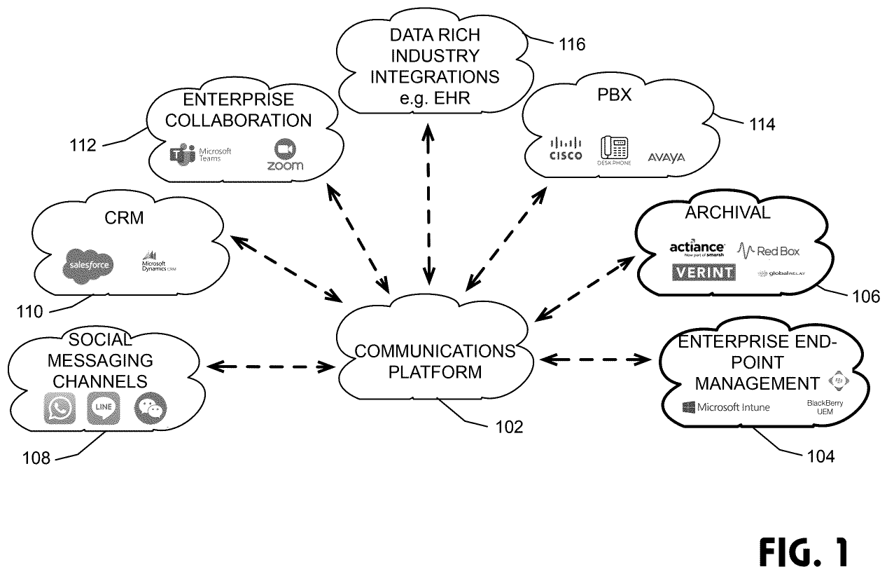

FIG. 1 is a functional diagram illustrating the telecommunications integration goal of various embodiments of the present invention. The listing of various communication sources, sinks, participants, etc., should not be viewed as comprehensive but rather as illustrative of the versatility of the various embodiments.

At the core of the integrated telecommunications illustrated in FIG. 1 (communications platform 102) is the traditional voice and SMS (short message service) or MMS (Multimedia Messaging Service). However, in addition to those two fundamental channels of communication (reference 102), the disruption of the various embodiments present invention may also bring together, from left to right:
(1) Multiple social messaging channels 108, such as WhatsApp, WeChat, Line (as non-limiting examples) all tied to this single unique number and without needing separate application interfaces OR separate identifiers;
(2) CRM cloud 110 illustrates the extension of the ability to receive or send calls and messages (include SMS, MMS, Social Messaging) within a multitude of CRM (Customer Relationship Management) systems without needing separate phone numbers or identities;
(3) Enterprise collaboration cloud 112 illustrates the extension of the ability for the users to be able to use the same phone number or identity within Unified Communication solutions (like MS Teams or Zoom or Cisco Webex or others) such that users can now spend their time productively without switching interfaces to connect with different people in their preferred ecosystems;
(4) PBX cloud 114 illustrates the seamless integration with PBX (Private Branch Exchange) systems eliminating the need for multiple phone numbers and multiple islands of communication (Fixed vs. Mobile); and
(5) Last but certainly not the least, security is preserved at each endpoint, at each interface and at each interaction with seamless integrations into Enterprise Mobility Management Solutions-104.

All of these above-described interactions can then be seamlessly integrated and ingested contextually and tied to that single unique identifier into the applicable System of Records systems like: Electronic Health Records (E H R) systems in health care 116; and a multitude of archival platforms used in several commercial and defense systems 106.

If we take a step back, and envision this disruption, this single number (identity) traversing multiple disparate communication islands and technologies would become the holy grail of simplification (as opposed to increasing the complexity), unification (as opposed to fragmentation), data amalgamation (as opposed to data silos), accessibility of information (as opposed to context switching from technology to technology) and bringing the notion of the identity tied to a position in a business not a specific individual, and that identity can be transferred seamlessly (people change, positions remain). All of this is achieved without creating a telecommunication standard or network specific solution.

A communications platform 102 is illustrated as being the central agent for enabling cross-communication among various sources, sinks, participants and technologies. The communications platform 102 may be an artificial intelligence (AI) powered, purpose driven, secure communications platform. The communications platform 102 can operate in a personal domain, an enterprise or business domain, or a hybrid of the two. Within the personal domain, the communications platform 102 seamlessly integrates the communications activity of a user including activities such as social media posts, social messaging channels, calendar activities, household management activities such as notifications from connected houses (i.e., ALEXA, SIRI, GO GOOGLE, SAMSUNG SMART THINGS, etc.), family schedules, school notifications, etc.

Within the business domain, the communications platform 102 seamlessly integrates into enterprise workflows and SaaS apps.

A workflow is a system for managing repetitive processes and tasks which occur in a particular order. They are the mechanism by which people and enterprises accomplish their work, whether manufacturing a product, providing a service, processing information or any other value-generating activity.

Within business process management, a workflow can be defined as a simple series of individual tasks, while a business process is considered more complex, consisting of multiple workflows, information systems, data, people and their activity patterns. A workflow is distinguished by its simplicity and repeatability, and it is generally visualized with diagram or checklist.

Workflow management software assists in simplifying and optimizing a business process within an organization. It largely does this by coordinating interactions among different stakeholders or between individuals and information systems. Workflow management systems route tasks to the appropriate employee at the right time, providing the pertinent information and nudge to expedite work along the overall process. It also supports manual and automated tasks through document management for activities, like expense reports.

Saas (Software As A Service) is a form of cloud computing in which the provider offers the use of application software to a client and manages all the physical and software resources used by the application. The distinguishing feature of SaaS compared to other software delivery models is that it separates the possession and ownership of software from its use.

As such, the communications platform 102 operates to tie in a wide variety of business activities that operate in the realm of workflows and SaaS. For instance, one such activity includes enterprise end-point management 104. Examples of this activity include Microsoft Intune, which is a cloud-based unified endpoint management service for both corporate and BYOD devices. It extends some of the “on-premises” functionality of Microsoft Endpoint Configuration Manager to the Microsoft Azure cloud. Another example includes the BlackBerry UEM, which delivers complete, unified endpoint management and policy control for a company's diverse and growing fleet of devices and apps. The BlackBerry UEM includes a single management console and trusted end-to-end security model. The BlackBerry UEM is designed to help increase the productivity of a company's mobile workforce while ensuring the full protection of the company's business data.

The communications platform 102 also facilitates archive integration 106. The communications platform 102 enables cloud-based recording of communications and data. The communications platform 102 enables the cloud-based recording to accessed by any EUD and thus, provides compliance, gap-free recording of messages regardless of the location of the EUD. This capability also allows the EUD to transfer recorded communications and data to preferred archival solutions for long-term retention and to have a level of confidence in the securement, retention and accuracy of recorded communications and messaging data. Advantageously, this capability simplifies the supervision, analysis, reporting and eDiscovery of the communications and data. Recordings, files, message streams, etc. can be automatically uploaded to any archival solution from any EUD utilizing the communications platform. Archival solutions may include DUBBER, VERINT, GLOBAL RELAY, VERBA, NICE, SOTERIA, REDBOX, ACTIANCE, AND SPLUNK, as non-limiting examples.

The communications platform 102 also facilitates the consolidation of business mobile messaging channels 108. Messages can be exchanged with consumers on multiple platforms, texting and social messaging, including WhatsApp, WeChat, and LINE etc. in a seamless and integrated manner. Advantageously, EUD can thus communicate with any customer over any of the messaging channels without requiring the customer to adapt to the messaging channel of the EUD and also giving the EUD the freedom to utilize a preferred messaging channel. Further, this aspect of the communications platform 102, regardless of if the EUD is an enterprise device or a BYOD, provides more ways in which clients can keep in touch, maintains professionalism by enabling messaging using official business accounts, and avoids the hassle, expense and time waste of utilizing multiple EUDs.

It should be appreciated that the communications platform 102 also facilitates a cross-blend or combination of the various integrations. For instance, consolidating mobile messaging channels 108 also is integrated with the recordation of messages and the archiving of the same 106. Message recording includes messages, picture messaging, group messaging, and automated messages, such as opt-ins. For instance, an opt-in asks for and captures consent send messages from your business. Opt-in and texting disclaimers can be generated and delivered according to local requirements. In addition, redaction, the action of automatically preventing prohibited terms or information from being shared over messages or stored in your archives can also be integrated across the various channels and EUDs.

Along the same lines, many companies still employ the utilization of PBX systems for inter and extra company communications. This is especially true for work forces that do not have to be on the go but rather are able to be positioned at their stations, desks or offices. The communications platform 102 facilitates the consolidation of business messaging and communication channels through the use of PBX systems 114. Thus, state of the art PBX systems such as CISCO and AVAYA, as non-limiting examples, are seamlessly integrated by means of the communications platform 102.

Advantageously, the communications platform 102 provides seamless mobility in the personal and business domains. In the business domain, users can send messages from their desktop phones, desktop computers, MICROSOFT TEAMS, SALESFORCE CRM, etc. Thus, the employees can message at their desk or on the go with mobile EUDs. Employees can efficiently send messages utilizing their computer keyboard by using Desktop or Microsoft Teams integrations.

It can thus be appreciated that the communications platform 102 also greatly facilitates seamlessly integrating CRM activities 110. CRM is typically used to refer to customer relationship management software that provides the ability to track each interaction that employees have with prospects or customers. This interaction can include activities such as sales calls, customer service interactions, marketing emails, strategic brainstorming among colleagues, and more. CRM tools can unify customer and company data from many sources and even use AI (artificial intelligence) to help better manage relationships across the entire customer lifecycle, spanning departments like marketing, sales, digital commerce, and customer service interactions. The communications platform 102 thus seamless integrates a variety of commercially available CRM systems such as SALESFORCE, MICROSOFT DYNAMICS 365, HUBSPOT, PIPEDRIVE, MONDAY SALES CRM, etc. Thus, regardless of the EUD utilized for CRM, embodiments of the communications platform 102 may enable the data to be accessible to any other EUD.

An ever-increasing focus in today's workplace stems around the phrase “enterprise collaboration”. Enterprise collaboration is the process of helping diverse employees engage in teamwork across borders such that remote and local workers can participate in day-to-day tasks like file sharing, project management, and social media, all through one cohesive online system. With the influx of technology companies trying to create and market the “perfect enterprise collaboration” system, companies have acquired and adopted several solutions such as MICROSOFT TEAMS, SKYPE, ZOOM, etc. Another advantage of the communications platform 102 is the ability to seamlessly integrate various enterprise collaboration systems 112.

In addition to all the above, there are many additional industries that are classified as “data rich” industries, meaning that their day-to-day operations generate, collect, store, and depend on large amounts of data. Typically, this data needs to be reliably stored, securely protected and easily accessible by authorized EUDs. Advantageously, the embodiments of the communications platform 102 seamlessly integrate data rich industries 116, such as Electronic Health Records (EHR) in the health industry, banking and securities, media and entertainment, pharma and healthcare, education, manufacturing, insurance, transportation, government, energy and utilities, and retail and wholesale as non-limiting examples.

It should be understood by anyone in the industry, mobile messaging is a reality of doing business and it is going to be around for a long time. As such, it is imperative that companies give their employees a way to do business, easily and compliantly. The embodiments of the present invention provide technical solutions and platforms in which one or more of the afore-described advantages and aspects can be achieved.

The various embodiments of the communications platform provide the afore-described seamless integration through the use of a single number. In general, in one embodiment, each EUD that is serviced by the communications platform 102 is associated with a single unique number. That number is used in connection with all forms of communication with that EUD and the unique numbers can be tracked on behalf of various entities. For instance, on a personal level, a user may utilize 10 EUDs for various communication needs. The unique numbers associated with these EUDs all result in causing the telecommunications infrastructure to forward control of all such communications for these EUDs to the communications platform 102. At the communications platform 102, all these 10 unique numbers associated with the users 10 EUDs can be all tied together as being related to the same user. As such, the communications platform 102 can seamlessly integrate all communications associated with these EUDs.

In other embodiments, the EUDs owned or utilized by a particular entity may all include an identification number associated with that entity. As such, all communications that utilize that unique identification number can be seamlessly integrated by the communications platform 102.

In yet other embodiments, each of the EUDs may include unique identification numbers and the communications platform 102 can include various rules and categorizations to associate various unique identification numbers with various entities. For instance, Table 1 illustrates how a communications platform 102 could associate various unique identification numbers with various entities.

TABLE 1

| | | Associated | Associated | Associated |
|---|---|---|---|---|
| | | with | with | with User A |
| Unique ID | | User A | User B | and B's |
| Number | EUD | personal | personal | employer |
| UIDN0001 | User A's | Yes | No | Yes |
| | BYOD phone | | | |
| UIDN0002 | User B's | No | Yes | Yes |
| | BYOD phone | | | |
| UIDN0003 | User A's | Yes | No | Yes |
| | ZOOM account | | | |
| UIDN0004 | User A's | Yes | No | No |
| | FACEBOOK acct | | | |

In this simplified example, the communications platform 102 associates User A's BYOD phone, User B's BYOD phone and User A's ZOOM account with the employer of User A and User B. In addition, User A's BYOD phone, User A's ZOOM account and User A's FACEBOOK account are all associated with User A personally. Likewise, User B's BYOD phone is personally associated with User B.

As such, in some embodiments, all EUDs associated with a user or an entity may utilize the same unique ID for that user or entity or, each EUD may have a unique ID and the communications platform 102 can associate one or more of the unique IDs with various users and/or entities. In the former case, communications associated with EUDs and identified by the unique IDs may also include further information to identify the identity of the type of EUD so that the communications platform can process the data appropriately (i.e., translate a FACEBOOK messenger such that it can be received by a WHATSAPP app).

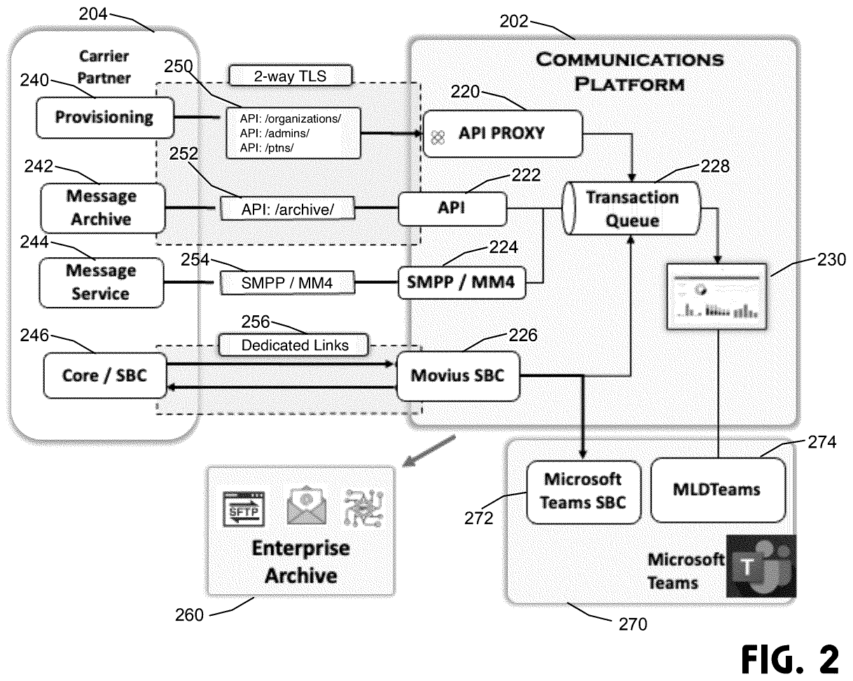

FIG. 2 is a functional block diagram illustrating the operation of an exemplary communications platform interacting with a carrier partner providing certain integrated communication services. The exemplary communications platform 202 is illustrated as interfacing with a carrier partner 204. It should be appreciated that the carrier partner 204 can be any participating carrier, such as brand name mobile provides (i.e., T-MOBILE) as well as small tier equipment lessees that also provide wireless service or any other communications or technology company that may be equipped to receive communication requests initiated by EUDs. Further, it should be understood, that while one carrier partner is illustrated in FIG. 2 multiple carrier partners may exist simultaneously and interface to the communications platform 202.

Initially the Carrier Partner 204 provisions the EUDs that are slated to receive or that are subscribed to the communications integration services provided through various embodiments of the present invention. As such, the Carrier Partner 204 operates initially to provision customers, admins, and lines. The Carrier Partner 204 provides the provisioning of the customers, admis, and lines by employment of a provisioning function 240 by the Carrier Partner 204 what interfaces with an API (Application Protocol Interface) proxy 220 provided by the communications platform 202 over one or more 2-way TLS communication channels.

TLS or Transport layer security is a cryptographic protocol that provides end-to-end security of data sent between applications over the Internet. TLS evolved from secure socket layers (SSL), which NETSCAPE COMMUNICATIONS CORPORATION developed in 1994 to secure web sessions.

TLS is normally implemented on top of transmission control protocol (TCP) in order to encrypt application layer protocols such as HTTP, file transfer protocol (FTP), simple mail transfer protocol (SMTP) and internet message application protocol (IMAP), although it can also be implemented on user datagram protocol (UDP), datagram congestion control protocol (DCCP) and stream control transmission protocol (SCTP), as well.

The Carrier Partner 204 operates to provision for the integrated communications service provided through the communications platform 202 for any form of EUD that is leveraging the service. In essence, during the provisioning process the Carrier Partner 204 receives a unique identifier that is associated with the EUD. The Carrier Partner 204 then associates that unique identifier with that particular EUD and tags the EUD and unique identifier as being services by the communications platform 202. As a result of the provisioning, any and all forms of communication that are directed through the Carrier Partner 204 and that include the unique ID, are captured by the Carrier Partner 204 and routed to the communications platform 202. Thus, any communications technology that the communications platform is servicing, such as calls, messages, delivery to CRM, video conferences, etc., are captured by the Carrier Partner 204 and once the unique identifier is recognized, the communications are routed to the communications platform 202. In the illustrated example, the provisioning by the Carrier Partner 204 can be accomplished by invoking one or more particular API proxy functions, such as the three listed in proxy function block 250, namely API:/organizations/, API:/admins/, and API:/ptns/.

One of the features or operations of the communications platform 202 is the provision and/or orchestration of archival services. The archival services can be provided by the communications platform 202 as messages or communications are received from the Carrier Partner 204 or directly by the communications platform 202. For communications received by the communications platform 202, the communications platform 202 may store directly into enterprise archive 260 or may send to a message archive 242 function provided by the Carrier Partner 204. For communications received by the Carrier Partner 204, the Carrier Partner 204 can either provide to the communications platform 202 for storage within the enterprise archive 260 by means of an API call 252 (i.e., API:/archive/) to the API 222 of the communications platform 202. Alternatively, the Carrier Partner may transmit the messages to be archived to the communications platform 202 by means of an SMPP transmission. Further, rather than sending messages to storage by the communications platform 202, the Carrier Partner 204 may archive the messages directly and simply forward notification of the same to the communications platform 202. Further, the Carrier Partner 204 may utilize a distributed archival system that can be accessed by other carrier partners and/or the communications platform 202. Further, in some embodiments, the Carrier Partner 204 and the communications platform 202 may maintained duplicate and redundant archives of all communications.

As previously described, one of the functions or features of the communications platform 202 is the ability to provide seamless integration of a wide variety of EUDs, and ultimately to be able to provide seamless integration to all EUDs. This is a very powerful and dynamic feature of the communications platform. In essence, the communications platform can be viewed as the communications unifier overcoming the inability to communicate across diverse channels and languages (or communication techniques protocols, etc.). This capability if provided through the communications platform 202, and in some circumstances with cooperation from the Carrier Partner 204. For instance, the communications platform 202 may directly receive, process and direct communications between EUDs, or may receive communications directed to the communications platform 202 from the Carrier Partner 204. In this latter scenario, a message service 244 of the Carrier Partner 204 receives messages that include the unique ID, then then invokes transmission or forward of the same to the communications platform by issuing an SMPP or MM4 transfer 254 through and SMPP/MM4 interface 224 of the communications platform 202. Likewise, the core/SBC function 246 of the Carrier Partner 204 can receive calls that are associated with the unique ID and then forward the calls to the communications platform 202 via dedicated links between the Carrier Partner 204 and the SBC 256 interface 226 of the communications platform 202. The dedicated lines 256 enable communications to be exchanged securely and reliably between the Carrier Partner 204 and the communications platform 202 with minimal latency.

An SBC (or session border controller) is a network element deployed to protect Session Initiation Protocol (SIP) based communications occurring over the Internet Protocol, such as voice over Internet Protocol (VOIP) as a non-limiting example. Early deployments of SBCs were focused on the borders between two service provider networks in a peering environment. This role has now expanded to include significant deployments between a service provider's access network and a backbone network to provide service to residential and/or enterprise customers.

The term “session” refers to a communication between two or more parties—in the context of telephony, this would be a call. Each call consists of one or more call signaling message exchanges that control the call, and one or more call media streams which carry the call's audio, video, or other data along with information of call statistics and quality. Together, these streams make up a session. It is the job of a session border controller to exert influence over the data flows of sessions.

The term “border” refers to a point of demarcation between one part of a network and another. As a simple example, at the edge of a corporate network, a firewall demarcates the local network (inside the corporation) from the rest of the Internet (outside the corporation). A more complex example is that of a large corporation where different departments have security needs for each location and perhaps for each kind of data. In this case, filtering routers or other network elements are used to control the flow of data streams. It is the job of a session border controller to assist policy administrators in managing the flow of session data across these borders.

The term “controller” refers to the influence that session border controllers have on the data streams that comprise sessions, as they traverse borders between one part of a network and another. Additionally, session border controllers often provide measurement, access control, and data conversion facilities for the calls they control.

SBCs commonly maintain full session state and offer the functions such as:
security to protect the network and other devices from malicious attacks (i.e. denial of service), toll fraud via rogue media streams, malformed packet protection, and encryption of signaling and media;
connectivity to allow different parts of the network to communicate through the use of a variety of techniques including NAT traversal, SIP normalization via SIP message and header manipulation, IPv4 to IPv6 interworking, VPN connectivity and Protocol translations between SIP, SIP-I, H.323;
quality of service (QoS) policy of a network and prioritization of flows including traffic policing, resource allocation, rate limiting, call admission control, and ToS/DSCP bit setting;
regulatory support such as emergency call prioritization and lawful interception;
media services though built-in digital signal processors (DSPs) to enable them to offer border-based media control and services such as DTMF relay and interworking, media transcoding, tones and announcements, data and fax interworking, support for voice and video calls; and
statistics and billing information because all sessions that pass through the edge of the network pass through the SBC, it is a natural point to gather statistics and usage-based information on these sessions.

SBCs are inserted into the signaling and/or media paths between calling and called parties (eg. Within a VoIP call), predominantly those using the Session Initiation Protocol (SIP), H.323, and MGCP call-signaling protocols.

In many cases the SBC hides the network topology and protects the service provider or enterprise packet networks. The SBC terminates an inbound call and initiates the second call leg to the destination party. The effect of this behavior is that not only the signaling traffic, but also the media traffic (voice, video) is controlled by the SBC. In cases where the SBC does not have the capability to provide media services, SBCs are also able to redirect media traffic to a different element elsewhere in the network, for recording, generation of music-on-hold, or other media-related purposes. Conversely, without an SBC, the media traffic travels directly between the endpoints, without the in-network call signaling elements having control over their path.

In other cases, the SBC simply modifies the stream of call control (signaling) data involved in each call, perhaps limiting the kinds of calls that can be conducted, changing the codec choices, and so on. Ultimately, SBCs allow the network operators to manage the calls that are made on their networks, fix or change protocols and protocol syntax to achieve interoperability, and also overcome some of the problems that firewalls and network address translators (NATs) present for VoIP calls.

To show the operation of an SBC, one can compare a simple call establishment sequence with a call establishment sequence with an SBC. In the simplest session establishment sequence with only one proxy between the user agents the proxy's task is to identify the callee's location and forward the request to it. The proxy also adds a Via header with its own address to indicate the path that the response should traverse. The proxy does not change any dialog identification information present in the message such as the tag in the From header, the Call-Id or the Cseq. Proxies also do not alter any information in the SIP message bodies. Note that during the session initiation phase the user agents exchange SIP messages with the SDP bodies that include addresses at which the agents expect the media traffic. After successfully finishing the session initiation phase the user agents can exchange the media traffic directly between each other without the involvement of the proxy.

SBCs are designed for many applications and are used by operators and enterprises to achieve a variety of goals. Even the same SBC implementation might act differently depending on its configuration and the use case. Hence, it is not easily possible to describe an exact SBC behavior that would apply to all SBC implementations. In general, it is possible to identify certain features that are common to SBCs. For example, most SBCs are implemented as back-to-back user agent. A proxy-like server can split an SIP transaction in two call legs: on the side facing the user agent client (UAC), it acts as server, on the side facing user agent server (UAS) it acts as a client. While a proxy usually keeps only state information related to active transactions, it may keep state information about active dialogs, e.g., calls. That is, once a proxy receives a SIP request it will save some state information. Once the transaction is over, e.g., after receiving a response, the state information will soon after be deleted. The state information may be maintained for active calls and only deleted once the call is terminated.

When an SBC is included in the call path, the SBC operates as a user agent server towards the caller and as user agent client towards the callee. In this sense, the SBC actually terminates that call that was generated by the caller and starts a new call towards the callee. The INVITE message sent by the SBC no longer may contain a clear reference to the caller. The INVITE sent by the SBC to the proxy includes Via and Contact headers that point to the SBC itself and not the caller. SBCs often also manipulate the dialog identification information listed in the Call-Id and From tag. Further, in case the SBC is configured to also control the media traffic then the SBC also changes the media addressing information included in the c and m lines of the SDP body. Thereby, not only will all SIP messages traverse the SBC but also all audio and video packets. As the INVITE sent by the SBC establishes a new dialog, the SBC also manipulates the message sequence number (CSeq) as well the Max-Forwards value. Note that the list of header manipulations listed here is only a subset of the possible changes that an SBC might introduce to a SIP message. Furthermore, some SBCs might not do all of the listed manipulations. If the SBC is not expected to control the media traffic then there might be no need to change anything in the SDP body. Some SBCs do not change the dialog identification information and others might even not change the addressing information.

SBCs are often used by corporations along with firewalls and intrusion prevention systems (IPS) to enable calls (eg., VOIP calls) to and from a protected enterprise network. Call service providers use SBCs to allow the use of particular protocols from private networks with Internet connections using NAT, and also to implement strong security measures that are necessary to maintain a high quality of service. SBCs also replace the function of application-level gateways. In larger enterprises, SBCs can also be used in conjunction with SIP trunks to provide call control and make routing/policy decisions on how calls are routed through the LAN/WAN. There are often tremendous cost savings associated with routing traffic through the internal IP networks of an enterprise, rather than routing calls through a traditional circuit-switched phone network.

Additionally, some SBCs can allow calls to be set up between two phones using different signaling protocols (e.g., SIP, H.323, Megaco/MGCP) as well as performing transcoding of the media stream when different codecs are in use. Most SBCs also provide firewall features for call traffic (denial of service protection, call filtering, bandwidth management). Protocol normalization and header manipulation is also commonly provided by SBCs, enabling communication between different vendors and networks.

In the illustrated example of FIG. 2, the communications platform 202 is shown as interfacing with Microsoft Teams 270. It will be appreciated that the exemplary architecture and interface with any of a wide variety of applications and/or EUDs such as Microsoft Teams and the use of Microsoft Teams is simply provided as an example. The communications platform 101 interfaces to a Microsoft Teams SBC 272 for voice and/or video content while messages and data can be provided through an MLDTeams application 274. Messages received from the Carrier Partner 204 are placed into a transaction queue 228 and the content 230 can then be transferred to Microsoft Teams 270 via the MLDTeams interface 274.

The architecture illustrated in FIG. 2 also enables FCC compliance, Legal Intercept Compliance, and Emergency Communications Compliance.

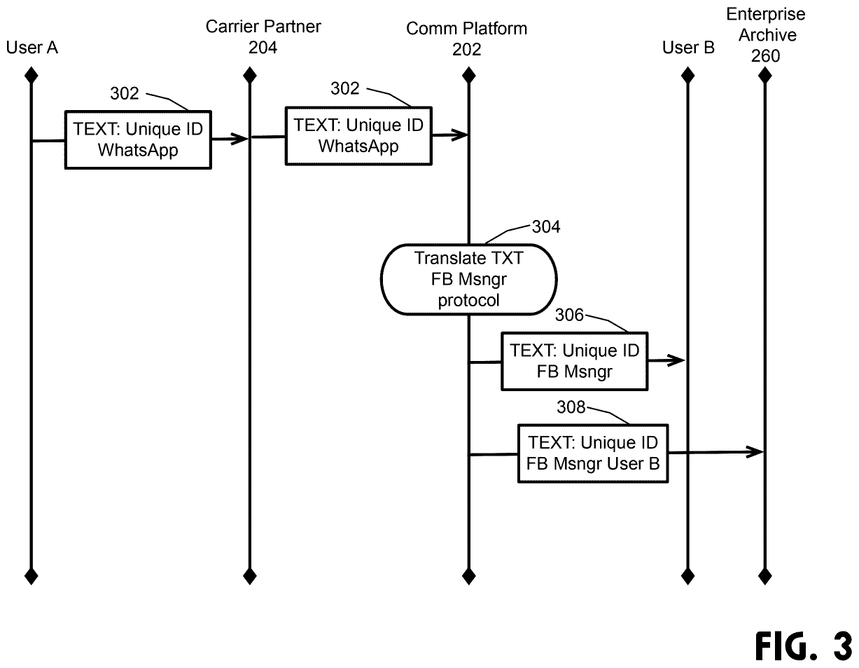

A few practical examples of the operation of the architecture illustrated in FIG. 2 are presented. FIG. 3 is a flow diagram illustrating a first communication exchange example based on an exemplary architecture such as that illustrated in FIG. 2 as a non-limiting example. In this example, assume that User A utilizes WhatsApp to talk with User B who uses FB Messenger and that User B is utilizing an EUD that subscribe to the integrated communications service provide by the communications platform 202. Initially, User A sends a text 302 to User B, the text includes the destination of User B. The Carrier Partner 204 sees the User B destination and determines that it is to be processed by the communications platform 202. As such, the Carrier Partner 204 forwards the message 302 to communications platform 202. The communications platform then identifies the destination of the message and determines that the message is directed to a particular EUD with a particular unique ID and that has a preference known to the communications platform 202 of using FACEBOOK MESSENGER for exchanging of texts messages. The communications platform 202 then performs a protocol translation of the message from WHATSAPP to FACEBOOK MESSENGER 304 and forwards the message to the intended destination 306-User B. The communications platform 202 may also record the message into the Enterprise Archive 260 for User B in FACEBOOK MESSENGER format 308 tied to the unique ID.

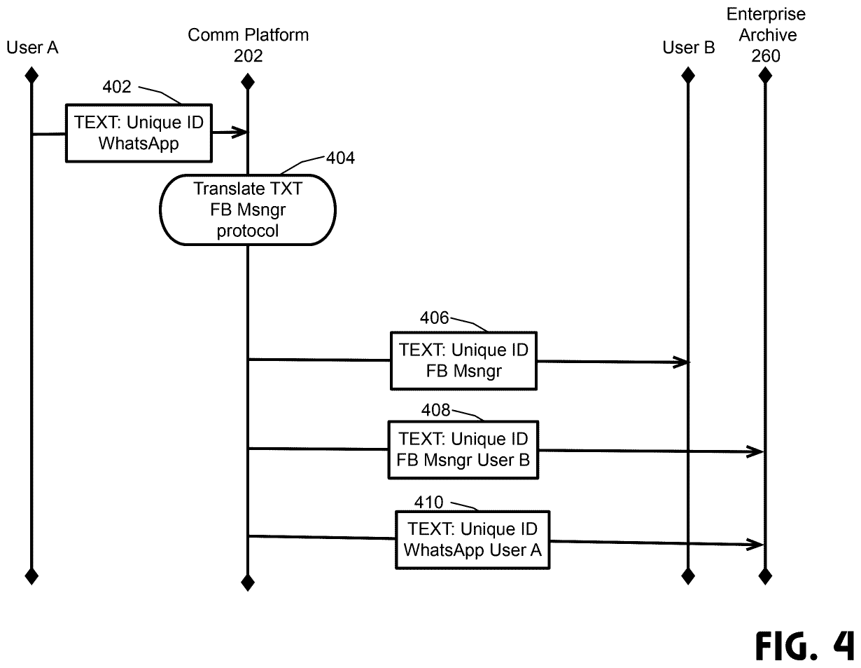

FIG. 4 is a flow diagram illustrating a communication exchange example based on an exemplary architecture such as that illustrated in FIG. 2. In this example, assume that User A utilizes WhatsApp to talk with User B who uses FB Messenger and that both User A and User B are utilizing EUDs that subscribe to the integrated communications service provide by the communications platform 202. Initially, User A sends a text 402 to User B, the text includes the unique ID of User A and the destination of User B. The text 402 is received by the communications platform 202. The communications platform 202 then identifies the destination of the message and determines that the message is directed to a particular EUD what has a preference of using FACEBOOK MESSENGER for exchanging of texts messages. The communications platform 202 then performs a protocol translation of the message from WHATSAPP to FACEBOOK MESSENGER 404 and forwards the message to the intended destination 406-User B using the unique ID of User B. Communications platform 202 may employ the multiline/multichannel technology presented in U.S. Pat. Nos. 11,563,711 and/or 9,332,128 (both of which are incorporated herein above by reference) in sending the communications between User A and User B. The communications platform 202 may also record the message into the Enterprise Archive 260 for User B in FACEBOOK MESSENGER format 408 and User A in WHATSAPP format 410.

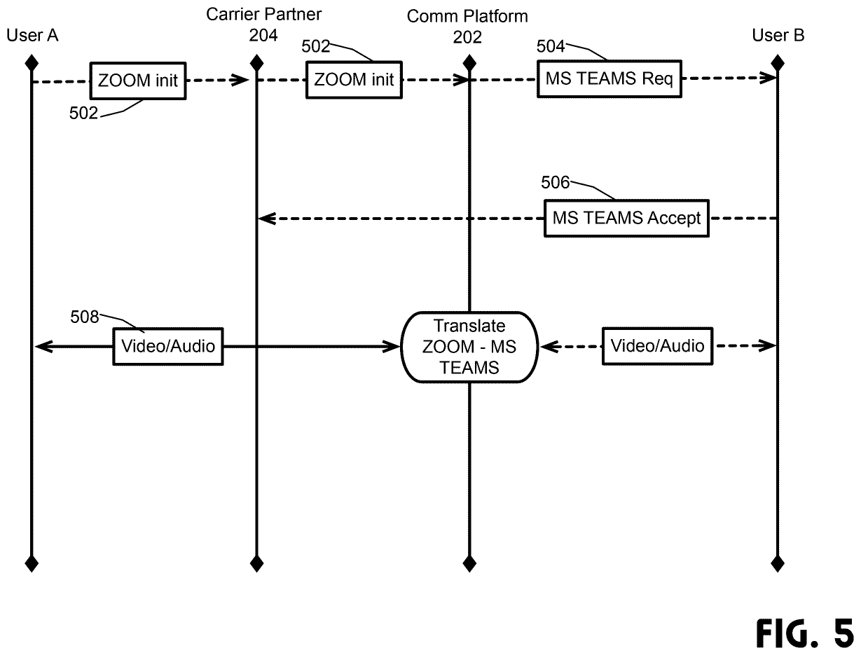

FIG. 5 is a flow diagram illustrating another communication exchange example based on an exemplary architecture such as that illustrated in FIG. 2. User A and User B enter a video conference with User A using ZOOM and User B using MICROSOFT TEAMS. The video conference is initially set up with User A initiating the conference with User B 502. During the setup process, the Carrier Partner 204 detects the unique ID of User A in setting up the conference call and forwards the setup request to the communication platform 202 to be processed. The communication platform 202 recognizes the unique ID for User A and the unique ID of User B and thus identifies both as subscribers to the service. The communication platform 202 then identifies that User B prefers MICROSOFT TEAMS and that User A prefers to use ZOOM. The communications platform 202 then sends an MS TEAMS request 504 to User B. Upon receiving an MS TEAMS accept 506 from User B the communication platform 202 completes the video call connection between User A and User B. Video and Audio between User A and the communication platform is in the ZOOM format and between the communication platform 202 and User B is in MICROSOFT TEAMS format 510. The communication platform 202 performs the translations as well as providing translations for messages transmitted between the two users, archived deposits, etc.

Thus, it should be appreciated that call or message communication happens through a carrier powered endpoint (mobile phone, tablet, connected device) and then that call arrives to the communication platform with a single unique identity. With that single unique identity, the communication platform can do several things using the multiline/multichannel technology presented in U.S. Pat. No. 9,332,128 for delivery to different end points (CRM, ZOOM, TEAMS, Messaging systems) and also to get the carrier to terminate as needed and appropriate.

What is important to various embodiments of the present invention is the provision of the single unique identifier from the EUD to invoke the provision of the integrated communication services by the communication platform. The single unique identifier is provided in various manners dependent upon the technology or protocol being employed during the communication setup. In general, it will be understood that the integrated communication services can be accessed by any EUD that is provisioned to operate over a carrier network or, any application or system that operates on such an EUD. As those skilled in the art will understand, a carrier provisioned EUD will include a Subscriber Identity Module (“SIM”) card or an Embedded Subscriber Identity Module (“ESIM”). The SIM card or ESIM is provisioned by the carrier and is unique to the EUD. When the EUD is utilized to set up a communication, such as placing a call, sending a text, sending and SMS, MMS, establishing a video conference, etc., the EUD must first transmit a setup request and that request will include the single unique identifier associated with the EUD or user of the EUD. The single unique identifier may be provisioned to the EUD by the operator of the communication platform or may be provisioned by the carrier in response to the operator of the EUD requesting such provisioning.

Under each of the cellular protocols, during a call setup request, the EUD transmits identifying information as to the originating party or unit. This is most typically in the form of calling line identifier (“CLID”); however, it should be appreciated that many protocols include additional space above and beyond just space in the protocol for the 10-digit phone number associated with the initiating device. As such, during a typical call setup, the EUD may provide the mobile identification number (“MIN”), unique SIM information, the network number that the EUD is provisioned with, as well as additional unique identification information. This information is provisioned into the EUD device by a carrier partner when the user is subscribing to the integrated communication services. This single unique identification number is provided to the carrier operator during all communication set up initiations and, the carrier operator receives the single unique identification number and forwards the communication setup request to the communications platform for processing as described above.

Certain actions or blocks in the processes or process flows described in this specification naturally precede others for the embodiment to function as described. However, the various embodiments are not limited to the order of the actions or blocks as presented or described. That is, it is recognized that some actions or blocks may be performed before, after, or in parallel (substantially simultaneously with) other actions or blocks without departing from the scope and spirit of the various embodiments. In some embodiments, certain actions or blocks may be omitted or not performed as not all embodiments necessarily must implement all of the described actions. Also, in some embodiments, multiple actions depicted and described as unique actions or blocks in the present disclosure may be comprised within a single step or block. Further, words such as “thereafter”, “then”, “next”, “subsequently”, etc. are not intended to limit the order of the actions or blocks. These words are simply used to guide the reader through the description of the exemplary method.

Additionally, one of ordinary skill in programming will be able to write computer code or identify appropriate hardware and/or circuits to implement the various embodiments, as well as features and aspects thereof, based on the flow charts and associated description in this specification. Therefore, disclosure of a particular set of program code instructions or detailed hardware devices is not considered necessary for an adequate understanding of how to make and use the various embodiments. The functionality of the claimed computer implemented processes is explained in more detail in the above description and in conjunction with the Figures that may illustrate various process flows.

Based on all of the above, as those of ordinary skill in the art would understand, under existing traditional technology the network services and identifiers have remained siloed and network specific, they were not unique across ecosystems. The uniqueness e of various embodiments of the present invention utilize a single identifier (an MSISDN, a SIM, an ESIM, or a uniquely asserted self-sovereign identity) to now bring all channels of communication and fragmented technologies together. Similar to the reversal of the Tower of Babel or, the user of a Babel Fish in the car as presented in Hitch Hikers Guide to the Galaxy.

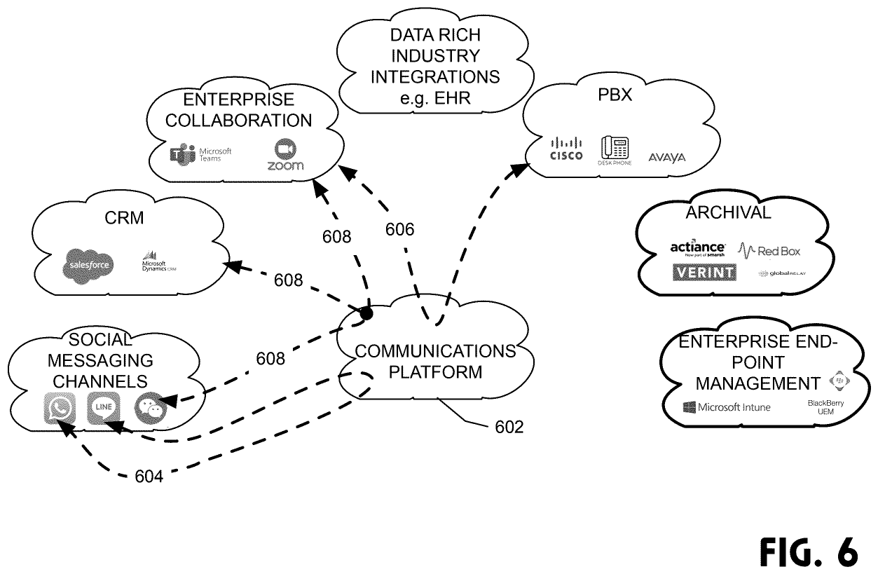

FIG. 6 is a sky of clouds illustrating the overall operation of an embodiment of an exemplary communications platform 602. The communications platform operates as the Babel Fish and enables communication between all of the various platforms, technologies, communications channels, terminal devices, communication applications, etc. A single unique identity is provided for each user, or each position, etc. This single unique identity is what the communications platform 602 utilizes to recognize a communications initiator and a communications recipient.

The communications platform 602 is shown as effectively operating in the middle of a complex orchestration of communication. A few scenarios are illustrated in FIG. 6. For instance, communication session 604 is between a first EUD using the WHATSAPP application and another EUD using the LINE messaging app. In this scenario, assume the communication was initiated by the user of the WHATSAPP application. That user initiates a connection to the user of the LINE messaging app. The communications platform 602 receives the communication initiation, either directly or as being recognized by the communications infrastructure (i.e. PSTN, MTN, etc), and recognizes the unique identification of the initiating EUD. The communications platform 602 also recognizes the destination and the unique identifier associated with the destination EUD. The communications platform 602 thus knows that the initiating EUD is communicating with the WHATSAPP application and the receiving EUD is communicating with the LINE messaging application. The communications platform 602 can perform any necessary translations on the communication between the two EUDs and store a history of the communications session into the archives for both EUDs.

As another example, communication session 606 is between an initiating EUD utilizing a ZOOM connection and receiving EUD utilizing a PBX connection. The communications platform 602 receives the communication initiation from the initiating EUD and recognizes the unique identifier associated therewith. The communications platform 602 also recognizes the unique identifier of the receiving EUD. The communications platform 602 operates as a bridge to enable these two disparate communications technologies to actually be engaged in a communications session. The communications platform 602 receives voice communications from the ZOOM app and converts it as necessary to send to the PBX and vice versa. The communications platform 602 is aware that the PBX cannot provide video or process video and as such, simply obtains and provides the voice communications from the ZOOM app. The communications platform 602 can also provide an indicator that the receiving EUD is not video capable by providing such information as a ZOOM avatar for the receiving EUD.

As another example, communication session 608 illustrates a one-to-many communications session established by a messaging app EUD with a MICROSOFT TEAMS EUD and a MICROSOFT DYNAMICS CRM EUD. Similarly, the communications platform recognizes the unique identifiers, identifies a language or protocol that can I be spoken to each EUD and coordinates the communication session.

Thus, it should be appreciated that the communications platform 602, utilizing the single unique identifiers for each EUD, can establish a communications session between any technology and breaks down the silos imposed by current state of the art technology.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, acoustic and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

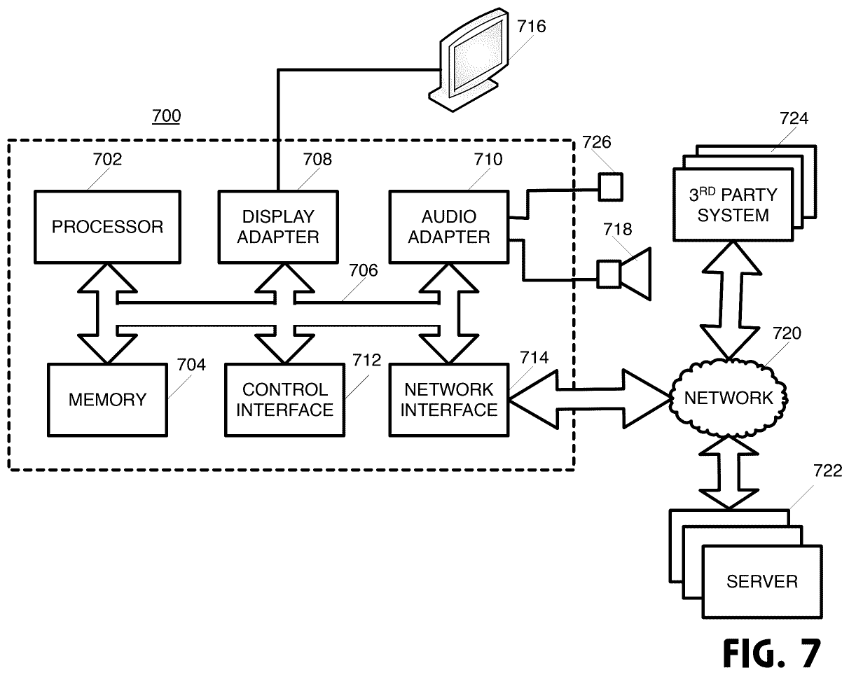

FIG. 7 is a functional block diagram of the components of an exemplary embodiment of system or sub-system operating as a controller or processor 700 that could be used in various embodiments of the disclosure for controlling aspects of the various embodiments. It will be appreciated that not all of the components illustrated in FIG. 7 are required in all embodiments of the activity monitor but, each of the components are presented and described in conjunction with FIG. 7 to provide a complete and overall understanding of the components. The controller can include a general computing platform 700 illustrated as including a processor/memory device 702/704 that may be integrated with each other or, communicatively connected over a bus or similar interface 706. The processor 702 can be a variety of processor types including microprocessors, micro-controllers, programmable arrays, custom IC's etc. and may also include single or multiple processors with or without accelerators or the like. The memory element of 704 may include a variety of structures, including but not limited to RAM, ROM, magnetic media, optical media, bubble memory, FLASH memory, EPROM, EEPROM, etc. The processor 702, or other components in the controller may also provide components such as a real-time clock, analog to digital convertors, digital to analog convertors, etc. The processor 702 also interfaces to a variety of elements including a control interface 712, a display adapter 708, an audio adapter 710, and network/device interface 714. The control interface 712 provides an interface to external controls, such as sensors, actuators, drawing heads, nozzles, cartridges, pressure actuators, leading mechanism, drums, step motors, a keyboard, a mouse, a pin pad, an audio activated device, as well as a variety of the many other available input and output devices or, another computer or processing device or the like. The display adapter 708 can be used to drive a variety of alert elements 716, such as display devices including an LED display, LCD display, one or more LEDs or other display devices. The audio adapter 710 interfaces to and drives another alert element 718, such as a speaker or speaker system, buzzer, bell, etc. The network/interface 714 may interface to a network 720 which may be any type of network including, but not limited to the Internet, a global network, a wide area network, a local area network, a wired network, a wireless network or any other network type including hybrids. Through the network 720, or even directly, the controller 700 can interface to other devices or computing platforms such as one or more servers 722 and/or third party systems 724. A battery or power source provides power for the controller 700. Therefore, although selected aspects have been illustrated and described in detail, it will be understood that various substitutions and alterations may be made therein without departing from the spirit and scope of the present invention, as defined by the following claims.

What is claimed is:

1. A method for servicing a communication from an originating entity, the method comprising the actions of:
receiving a communication initiation at a telecommunications network component, the communication initiation being sent from an originating entity and comprising a unique identifier, which is associated with the originating entity, and a destination entity identifier;
parsing the communication initiation at the telecommunications network component;
detecting the unique identifier in the communication initiation at the telecommunications network component;
the telecommunications network component providing the communication initiation, based at least in part on the unique identifier, to a communications platform;
the communication platform identifying the source of the communication initiation and the destination entity of the communication;
the communication platform establishing a communication channel between the originating entity and the destination entity;
subsequently to establishing the communication channel:
in response to receiving a communication transmission from the originating entity for the destination entity, the communication platform performing any conversion necessary for the destination entity to understand the communication transmission from the originating entity;
in response to receiving a communication transmission from the destination entity to the originating entity, the communication platform performing any conversion necessary for the originating entity to understand the communication transmission from the destination entity; and
the communication platform routing the translated communication transmissions between the originating entity and the destination entity.

2. The method of claim 1, wherein
parsing the communication at the telecommunications network component comprises recognizing by the telecommunications network component that the unique identifier is one that is serviced by the communications platform.

3. The method of claim 1, wherein the telecommunications network component is included within the communications platform and the action of providing the communication initiation to the communications platform comprises passing the communications initiation to the communications platform.

4. The method of claim 3, wherein the action of the communication platform establishing a communication channel between the originating entity and the destination entity comprises establishing a first leg of the communication channel between the communication platform and the destination entity and establishing a second leg of the communication channel between the communication platform and the originating entity.

5. The method of claim 4, wherein the action of establishing the first leg of the communication channel between the communication platform and the destination entity comprises using a telecommunications technology compatible with the destination entity.

6. The method of claim 4, wherein the action establishing the second leg of the communication channel between the communication platform and the destination entity comprises using a telecommunications technology compatible with the originating entity.

7. The method of claim 4, further comprising the communication platform entering the communication transmission into an archive for a user associated with the originating entity.

8. The method of claim 1, wherein the telecommunications network component is communicatively coupled to the telecommunications network component over a telecommunications network and the action of providing the communication initiation to the communications platform comprises transmitting the communications initiation to the communications platform.

9. The method of claim 8, wherein the action of the communication platform establishing a communication channel between the originating entity and the destination entity comprises establishing a first leg of the communication channel between the communication platform and the destination entity and establishing a second leg of the communication channel between the communication platform and the originating entity.

10. The method of claim 9, wherein the action of establishing the first leg of the communication channel between the communication platform and the destination entity comprises using a telecommunications technology compatible with the destination entity.

11. The method of claim 10, wherein the action establishing the second leg of the communication channel between the communication platform and the destination comprises using a telecommunications technology compatible with the originating entity.

12. The method of claim 8, further comprising the communication platform entering the communication transmission into an archive for a user associated with the originating entity.

13. The method of claim 1, wherein the originating entity can be any of a variety of end user devices (EUDs).

14. The method of claim 1, wherein the destination entity can be any of a variety of end user devices (EUDs).

15. The method of claim 1, wherein the destination entity and the originating entity can be any of a variety of end user devices (EUDs) and the action of the communication platform establishing a communication channel between the originating entity and the destination entity comprises establishing a communication path to the destination entity EUD that is technically compatible with the destination entity EUD and a communication path to the originating entity EUD that is technically compatible with the originating entity EUD.

16. The method of claim 15, wherein at least one of the destination entity EUD and the originating entity EUD is a video conferencing application and the action of establishing the communication path includes establishing a communication path that can carry video and audio to/from the destination entity EUD and/or the originating entity EUD.

17. The method of claim 15, wherein at least one of the destination entity EUD and the originating entity EUD is a messaging application and the action of establishing the communication path includes establishing a communication path that can carry text messages to/from the destination entity EUD and/or the originating entity EUD.

18. A system for servicing a communication from an originating entity, the system comprising:
a communications platform that is communicatively coupled to a telecommunications network through a plurality of interfaces;
the communications platform configured to:
receive a communication initiation through a telecommunications network component, the communication initiation being sent from an originating entity and comprising a unique identifier, which is associated with the originating entity, and a destination entity identifier;
parsing the communication initiation;
detecting the unique identifier in the communication initiation;
identifying the source of the communication initiation and the destination entity of the communication initiation; and
establishing a communication channel between the originating entity and the destination entity;
subsequent to establishing the communication channel, the communications platform configured to:
in response to receiving a communication transmission from the originating entity for the destination entity, performing any conversion necessary for the destination entity to understand the communication transmission from the originating entity;
routing the translated communication transmission form the originating entity to the destination entity using an interface of the plurality of interfaces that is compatible with the destination entity
in response to receiving a communication transmission from the destination entity to the originating entity, performing any conversion necessary for the originating entity to understand the communication transmission from the destination entity; and
routing the translated communication transmission to the originating entity using an interface of the plurality of interfaces that is compatible with the originating entity.

19. The system of claim 18, wherein the plurality of interfaces comprises two or more interfaces selected from a group of interfaces comprising:
an application program interface to a messaging service;
an interface to a social messaging platform;
an interface to a Customer Relationship Management (CRM) system;
an interface to an enterprise collaboration system; and
an interface to a private branch exchange system.

20. The system of claim 19, wherein the plurality of interfaces comprises
an interface to an archival system and the communications platform is configured to store a history of the translated communication transmissions from and to the originating entity.
